(19) United States
(12) Patent Application Publication
(10) Pub. No.: US 2015/0247058 A1
(43) Pub. Date: Sep. 3, 2015

(54) PAINTED MEMBER WITH FIBER-TEXTURED SURFACE AND METHOD FOR PREPARING THE SAME

(71) Applicant: Hyundai Motor Company, Seoul (KR)

(72) Inventors: Eun Ju Noh, Changwon (KR); Woo Chul Jung, Incheon (KR)

(21) Appl. No.: 14/569,663

(22) Filed: Dec. 13, 2014

(30) Foreign Application Priority Data
Mar. 3, 2014 (KR) 10-2014-0025115

(51) Int. Cl. C09D 175/04

(52) U.S. Cl. CPC C09D 175/04

(57) ABSTRACT

Disclosed is a painted member having a fiber-textured surface. The painted member has a superior fiber-textured surface and the surface is prepared by forming various embossing using a simplified painting method, rather than forming embossing on an injected surface. In particular, the various embossing is formed by forming a surface painting layer including expansion beads on a molded plastic substrate. Methods for preparing the painted member are also provided.

### CROSS-REFERENCE TO RELATED APPLICATION

This application claims under 35 U.S.C. §119(a) the benefit of Korean Patent Application No. 10-2014-0025115 filed on Mar. 3, 2014, the entire contents of which are incorporated herein by reference.

### TECHNICAL FIELD

The present invention relates to a painted member having a fiber-textured surface. The fiber-textured surface may be prepared in a simplified and more economical process by forming various types of embossing using a painting method, without forming embossing on an injected surface. In particular, the embossing may be formed by forming a surface painting layer that includes expansion beads on a molded plastic substrate. Methods for preparing the painted member having the fiber-textured surface are also provided.

### BACKGROUND

Generally, injected plastic articles have been used as interior materials in various interior structures such as vehicles and the like to reduce facility unit costs and more conveniently apply various structures. To provide a particularly more sophisticated or soft-fibered textures in such interior materials, in the related art, methods of forming embossing and painting on the surface of injected plastic articles to provide the soft texture have been commonly used.

However, in these methods of the related art, the injection may be performed after determining the shapes and the sizes of surface embossing when an injected plastic article is prepared. Further, the sizes and the shapes of the embossing formed on the injected article surface may be difficult to be arbitrarily adjusted to express various feeling and textures in various injected plastic article applications. Accordingly, obtaining diversity in shapes and sizes to express various textures of the surface may be limited

Often, various textures may be required for interior materials and the like of vehicles. However, methods of preparing embossing shapes formed on injected plastic articles have not been available in preparing products having sophisticated and various fiber textures.

In the related art, a method for preparing a flame retarding low density polyethylene-foamed resin has been developed. The flame retarding low density polyethylene-foamed resin is prepared by forming expanded or foamed beads in a low density polyethylene foamed mixture. Subsequently, the expanded beads are partially shrunk and the low density polyethylene foaming agent in which beads are expanded is cured by lowering a temperature to about 120 to 150° C.

In another example in the related art, mineral nonflammable, light-weight, insulating, sound absorbing and foaming beads, and molded articles in which these beads are foamed, and a method for preparing the same have been developed. In such methods, provided are molded articles that include porous mineral beads in which porous mineral fine granules are coated using a solvent in which an olefin polymer is dissolved or suspended with or without a foaming agent. Alternatively, the molded articles including porous mineral beads are coated with a foaming agent-containing olefin polymer formed by adding and polymerizing porous mineral fine granules and a foaming agent to a solution or suspension containing an olefin monomer.

In yet another example in the related art, a shock absorption member including an energy-absorbing foaming polymer has been provided. The shock absorption member is formed by extruding single continuous mass of a foaming resin mixture in an extrusion direction, formed by expanding expandable polymer beads, or formed in a reactive foaming process, as a shock absorption member having a dynamic shock application used in automotive interiors. In addition, a process for preparing expanded beads has been developed. The process includes a step of extrusion foaming polyalkylene terephthalate, and a step of melting threads becoming pellets and the process may be used for preparing gas-filled beads used in vehicle industry such as bumper shock absorption agents, seat core, and floor mat horizontal materials. Moreover, a method for producing regular polymer beads with methacrylic acid ester and/or acrylic acid ester as a base has been developed. The polymer beads are formed with an inorganic fine-particled filler and polymerized methacrylic acid ester or acrylic acid ester.

However, the aforementioned methods are typical technologies used for shock absorption and the like by preparing foaming molded articles using foaming beads rather than providing a surface texture. Thus, those technologies may not be suitable for interior materials having various surface textures. In particular, such methods used for shock absorption materials may not be applied to durable interior materials due to deterioration in durability of molded articles produced in the related art. In addition, although the above technologies may provide softness in a surface texture, when those are applied to prepare interior materials of a vehicle, durability or more sophisticated fiber texture thereof may not be obtained, and a surface texture may not be modified variously when the surface texture is obtained for integrated molded plastic articles.

The above information disclosed in this Background section is merely for enhancement of understanding of the background of the invention and therefore it may contain information that does not form the prior art that is already known in this country to a person of ordinary skill in the art.

### SUMMARY

We now provide this invention with interior materials which may provide various surface textures. In particular, a superior fiber-textured surface may be obtained in a simplified and more economical process by forming embossing when a surface painting layer including expansion beads is formed on a molded plastic substrate and is then dried. The embossing may be formed by the expansion of the beads in the surface painting layer based on the drying process.

Accordingly, the present invention provides a painted member with a fiber-textured surface formed with a surface painting layer containing expansion beads. In addition, provided is a method for preparing the painted member capable of giving a fiber-textured surface in various shapes and sizes using a simple and economical way such as drying a painting layer containing expansion beads.

In an exemplary embodiment, the painted member may include: a molded plastic substrate, and a surface painting layer that includes expansion beads coated thereon. Particularly, the expansion beads included in the surface painting layer may be exposed to the surface, and a fiber-textured surface may be obtained by the expansion beads.

In an exemplary embodiment, the method for preparing a painted member with a fiber-textured surface may include: preparing a molded plastic article; forming a surface painting layer by coating a paint composition which contains expansion beads on the surface of the molded plastic article; and drying the surface painting layer.

According to various exemplary embodiments of the present invention, improved natural embossing may be obtained by properly inducing the expansion of beads through adjusting a drying condition in the painting process instead of forming embossing in an injection process as in the related art. Therefore, shapes, sizes and the like of the embossing may be modified without limitation. In addition, the surface texture may be modified according to the drying condition of the surface painting layer on a molded plastic article, and thus, painted members with more luxurious and diverse surface textures may be prepared while simultaneously maintaining durability of molded plastic articles. Further, interior materials having fibrous textures may be prepared in a simplified and more economical manner by simply modifying surface embossing.

### BRIEF DESCRIPTION OF THE DRAWINGS

The above and other features of the present invention will now be described in detail with reference to certain exemplary embodiments thereof illustrated by the accompanying drawings which are given hereinbelow by way of illustration only, and thus are not limitative of the present invention, and wherein:

FIG. 1 illustrates an exemplary cross-sectional structure of an exemplary painted member with a fiber-textured surface according to an exemplary embodiment of the present invention; and

FIG. 2 illustrated an exemplary cross-sectional structure of an exemplary painted member with a fiber-textured surface according to an exemplary embodiment of the present invention.

Reference numerals set forth in the Drawings includes reference to the following elements as further discussed below.
10: Molded Plastic Substrate
20: Surface painting layer
21: Expansion Bead
22: Inorganic Filler
30: Primer Coating Layer
100: Painted Member

It should be understood that the appended drawings are not necessarily to scale, presenting a somewhat simplified representation of various exemplary features illustrative of the basic principles of the invention. The specific design features of the present invention as disclosed herein, including, for example, specific dimensions, orientations, locations, and shapes will be determined in part by the particular intended application and use environment.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Hereinafter reference will now be made in detail to various exemplary embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

In one aspect, the present invention provides a painted member having a fiber-textured surface. In an exemplary embodiment, the painted member may include a surface painting layer that includes a primer coating layer and expansion beads in a molded plastic substrate. The molded plastic substrate, as used herein, refers to a substrate which may have typical molded plastic structures used for various interior parts in a vehicle and the like. In certain exemplary embodiments, conventional substrates which are prepared by injection with embossing formed on the surface may be used without limitation. Accordingly, any type of substrate may be used whether or not embossing is formed on the molded plastic article surface.

In particular, the molded plastic substrates may be formed with, but are not limited to, a polypropylene resin and the like. Further, the molded plastic substrates prepared to be applicable to various interior materials for vehicles may be used. In addition, a surface painting layer formed on the molded plastic substrate may include expansion beads.

In certain exemplary embodiments, the surface painting layer may have a coating thickness of about 20 to 50 μm, or particularly of about 20 to 30 μm. When the thickness is less than a predetermined thickness, for example, less than about 20 μm, the size of expansion beads may be substantially oversized with respect to the coating thickness, and thus superior surface texture may not be obtained, and chemical resistance, scratch resistance, durability and the like may deteriorate. When the thickness is greater than a predetermined thickness, for example, greater than about 50 μm, the expansion beads may not be exposed to the surface, and thus, the surface texture may not be modified.

In certain exemplary embodiments, the surface painting layer including expansion beads may include, but are not limited to, polyester polyol, polyurethane dispersion and polycarbonate polyol as a resin component. Additionally, the surface painting layer may further include a curing agent in addition to expansion beads. The surface painting layer may further include an inorganic filler and additives. The resin composition used herein may include polyester polyol in an amount of about 5 to 25% by weight, polyurethane dispersion in an amount of about 10 to 35% by weight and polycarbonate polyol in an amount of about 5 to 15% by weight, based on a paint composition coated as the surface painting layer.

The polyester polyol, as used herein, may form a coating film with the polyurethane dispersion resin, and may fix the surface painting layer to the coating film with expansion beads, an inorganic filler, and the like, thereby providing touch sensitivity for the surface.

The molecular weight of the polyester polyol may have a molecular weight of about 5,000 to 20,000 Mw, or particularly of about 5,000 to 10,000 Mw. When the molecular weight is less than about 5,000 Mw, touch sensitivity may not be sufficient, and chemical resistance and abrasion resistance may be reduced. When the molecular weight is greater than about 20,000 Mw, thermal resistance, light resistance and the like may be reduced. In addition, the content of the polyester polyol may be in an amount of about 5 to 25% by weight, based on a paint composition coated as the surface painting layer. When the content is less than about 5% by weight, a surface texture may not be obtained. When the content is greater than about 25% by weight, surface properties such as abrasion resistance may be degraded. It is understood that percentage by weight of the content as disclosed herein are based on total weight of the paint composition, unless otherwise indicated.

The polyurethane dispersion resin, as used herein, may form a coating film with and fix the surface painting layer to the coating film with expansion beads and the inorganic filler, as the polyester polyol. In certain exemplary embodiments, a moisture-dispersed resin may be used for the polyurethane dispersion resin. The moisture-dispersed polyurethane dispersion resin may provide improved elasticity, abrasion resistance, chemical resistance and the like and suitable adhesion to various materials, and may be readily modified in resin hardness. Further, polyester dispersion having a hydroxyl group of hydroxide (OH) in the molecule may be used. The polyurethane dispersion may have a molecular weight of about 3,000 to 20,000 Mw. When the molecular weight is less than about 3,000 Mw, scratch resistance and chemical resistance may be reduced. When the molecular weight is greater than about 20,000 Mw, the surface texture may be inferior.

The polycarbonate polyol resin, as used herein, may improve chemical resistance and coating film hardness. When the content of the polycarbonate polyol resin is less than about 5% by weight, chemical resistance and scratch resistance may be reduced. When the content of the polycarbonate polyol resin is greater than about 15% by weight, the surface texture may deteriorate. Accordingly, the content thereof may be in an amount of about 5 to 15% by weight, based on a paint composition coated as the surface painting layer.

In certain exemplary embodiments, the surface painting layer may contain expansion beads, and the expansion beads may be used in an amount of about 2 to 10% by weight or particularly in an amount of about 3 to 6% by weight, based on the total paint composition used in the surface painting layer. When the used amount is less than about 2% by weight, sufficient surface touch sensitivity or cushion sensitivity may not be obtained. When the used amount is greater than about 10% by weight, surface durability may be reduced or a surface texture may be inferior. Further, since the bead expansion rate at a constant level may not be controlled, a uniform coating film texture may not be obtained.

The expansion beads, as used herein, may be included in paint composition and provide surface touch sensitivity by expansion when the painted surface paining layer is dried. In certain exemplary embodiments, the expansion beads may expand at a temperature in a range of about 80 to 120° C. based on the thermal resisting properties of the substrate. In addition, polypropylene (PP) materials, which may be used for a crash pad, a door trim and the like as interior materials of vehicles and the like, may be used as a base material of the expansion beads and may have heat resistance to external heat of about 110° C. Accordingly, expansion of the polypropylene expansion beads may be at a temperature of about 80 to 110° C.

In particular, the expansion beads may have a particle diameter size of about 50 to 500 μm, or particularly of about 60 to 200 μm as the size of the beads expanded after drying. Part of these expansion beads may be floated, and part of these may protrude over the surface due to the sizes, and consequently, a fabric texture may be obtained on the surface. Thus, when the sizes of the expansion beads included in the surface painting layer are greater than or less than a predetermined size, for example, greater than about 500 μm or less than about 50 μm, the sufficient surface texture may not be obtained.

Further, the paint composition coated as the surface painting layer may contain a curing agent in an amount of about 1 to 10% by weight, an inorganic filler in an amount of about 1 to 10% by weight, and additives in an amount of about 1 to 10% by weight, based on total weight of the paint composition. The curing agent, as used herein, may produce a coating film of paint by reacting with a hydroxyl group (OH) of the resin and form a cross-linking structure. In particular, commercially available curing used for general urethane reactions may be used without limitation. The curing agent may be one or a mixture of two or more selected from the group consisting of trifunctional isoporone diisocyanate-based curing agents, trifunctional hexamethylene diisocyanate-based curing agents, and diphenylmethane diisocyanate-based curing agents which may be used for oil-soluble paints may be used.

The curing agent may be included in an amount of about 1 to 10% by weight, or particularly, in an amount of about 5 to 8% by weight, based on total weight of the paint composition. When the content of the curing agent is less than a predetermined amount, for example, less than about 1% by weight, the curing reaction may not sufficiently occur, thereby resulting in deteriorated appearances and coating film property degradation. When the content is greater than a predetermined amount, for example, greater than about 10% by weight, workability may be reduced due to a reduced pot life in the manufacturing process, and an unreacted curing agent remaining after cross-linking may be produced. Thus, the curing agent in the range described above may be included.

The inorganic filler, as used herein, may be mineral fibers. The inorganic filler may be, but is not limited to, SiO₂—Al₂O₃—CaO-based mineral fibers. When such mineral fibers are used, the length thereof may be of about 5 to 10 μm. This mineral fiber may be present in a cured state floated to the surface of the surface painting layer, and thus a luxurious fiber texture of the surface may be obtained with expansion beads. The inorganic filler may be included in an amount of about 1 to 10% by weight, or particularly, in an amount of about 3 to 5% by weight, based on total weight of the paint composition. When the content of the inorganic filler is less than a predetermined amount, for example, less than about 1% by weight, a luxurious texture may not be obtained, since the effect may not be sufficient and the inorganic filler may not contribute to a fiber texture. When the content of the inorganic filler is greater than a predetermined amount, for example, greater than about 10% by weight, mineral fibers may not be linked to the resin remain in the paint, thereby deteriorating appearances and property of the surface painting layer or a coating film.

In certain exemplary embodiments, a surface painting layer may further contain urethane beads. The urethane beads may be additionally used for a surface texture, and the urethane beads may be, but are not limited to, polycaprolactone-diol (PCD) which may be polymerized, and 1,6-hexamethylene diisocyanate as the curing agent. In particular, the molecular weight of PCD may be in a range of about 500 to 2000 Mw. When the molecular weight is less than about 500 Mw, the polymerization with the curing agent may not occur. When the molecular weight is greater than about 2000 Mw, viscosity may increase, therefore bead form may not be prepared substantially. The content of the urethane beads may be in an amount of about 1 to 5% by weight, or particularly, of about 1.0 to 2.0% by weight, based on total weight of the paint composition. Accordingly, soft touch sensitivity may be obtained by placing the urethane beads on the surface of the coating film. The urethane beads may have a particle diameter size in a range of about 50 to 200 μm. When the size less than about a predetermined size, for example, less than about 50 μm, the effect may not be significant. When the size is greater than a predetermined size, for example, greater than about 200 μm, desired surface texture may not be obtained.

In certain exemplary embodiments, additives may be included in the surface painting layer. The additives may be, but are not limited to, one or more of a light stabilizer, a viscosity agent, a matting agent and the like. Particularly, the light stabilizer, as used herein, may be a hindered amine-based light stabilizer. The light stabilizer may be, but is not limited to, one, or more selected from the group consisting of bis-(2,2,6,6-tetramethyl-4-piperidinyl) sebacate (Tinuvin 770), bis-[N-methyl-2,2,6,6-pentamethyl-4-piperidinyl]sebacate, and tetrakis(2,2,6-tetramethyl-4-piperidinyl-1,2,3,4-butanetetracarboxylate. In addition, the viscosity agent may be, but is not limited to, one or a mixture of two or more selected from the group consisting of urethane-based, and acrylic-based viscosity agents. The matting agent, as used herein, may be used for modifying the luster of the surface after forming the coating film. The matting agent may be, but is not limited to, siloxane-based matting agents and the like.

In other certain exemplary embodiments, each of the other additives such as the light stabilizer, the viscosity agent, and the matting agent may be included in an amount of about 0.1 to 1% by weight in the paint composition used for the surface painting layer. In particular, the light stabilizer may be included in an amount of about 0.2 to 0.8% by weight, the viscosity agent in an amount of about 0.2 to 0.5% by weight, and the matting agent in an amount of about 0.2 to 0.8% by weight, based on total weight of the paint composition.

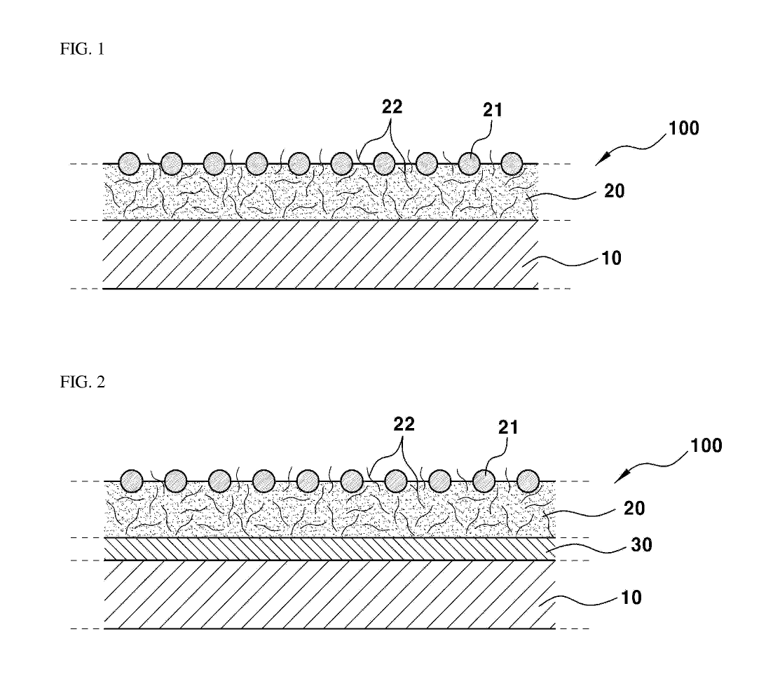

Moreover, the expansion beads included in the surface painting layer may be exposed to the surface as the expansion beads expand after drying, and a fiber-textured surface may be obtained by the expansion beads. The painted member with a fiber-textured surface may have an exemplary cross-sectional structural as shown in FIG. 1.

In FIG. 1, a surface painting layer (20) formed on the surface of a plastic substrate (10) that forms a basic shape of a painted member (100) may contain expansion beads (21), and the expansion beads may improve cushion sensitivity and slip sensitivity on the surface as they are exposed to the surface of the painted member (100). Accordingly, a fiber texture of the invention may be obtained. In particular, when the inorganic filler (22) is included in the surface painting layer (20), the surface slip sensitivity may be further improved.

According to certain exemplary embodiments, the painted member may further include a primer coating layer between the molded plastic substrate and the surface painting layer. As such, a painted member having improved physical properties may be prepared when such a primer coating layer is formed. As used herein, the primer coating layer may be an undercoating layer for the molded plastic substrate. The primer coating layer may include a paint composition including chlorinated polyolefine in an amount of about 15 to 35% by weight and polyacrylic urethane in an amount of about 20 to 40% by weight. In another exemplary embodiment, the paint composition of the primer coating layer may be about the same as the paint composition of the surface painting layer, but without expansion beads and urethane beads.

The primer coating layer may have a thickness of coating of about 1 to 20 μm, or particularly, of about 12 to 15 μm. In addition, the primer coating layer may be used to maintain a higher quality surface texture for an extended time without generating problems such as surface detachment when the surface painting layer is directly applied to a plastic molding layer. When the primer coating layer has a thickness greater than a predetermined thickness, for example, greater than about 15 μm, printing spray workability may deteriorate. When the primer coating layer has a thickness less than a predetermined thickness, for example, less than about 12 μm, the effect of application may not be obtained such that the durability of the surface painting layer may be reduced.

FIG. 2 illustrates an exemplary cross-sectional structure of a painted member with a fiber-textured surface in which an exemplary primer coating layer is formed according to an exemplary embodiment of the present invention. As shown in FIG. 2, a primer coating layer (30) may be formed on a plastic substrate (10), and a surface painting layer (20) may be formed thereon.

In other aspect, a method for preparing the painted member with a fiber-textured surface is provided. In an exemplary embodiment, the preparation method may include: preparing the molded plastic substrate; coating a surface painting layer; and drying the painted surface layer. In particular, in the process of preparing a molded plastic substrate, the plastic substrate may be an injection or extrusion molded product which may be suitable for the shaping of interior materials to apply a painted member. Alternatively, the plastic substrate may be in a sheet form.

The formation of an embossing on the surface of the molded plastic substrate may not be necessary, or alternatively, embossing may be formed on the plastic substrate as prepared above. In certain exemplary embodiments, the method may include a process of forming a surface painting layer by coating paint containing expansion beads on the surface of the molded plastic substrate. In particular, the surface painting layer may be coated using a spray method by forming the paint composition with the resin composition which may contain beads and other substances therein as described above.

In certain exemplary embodiment, the method may further include coating a primer coating layer prior to the formation of the surface painting layer. The primer coating layer may be coated using a spray method, without limitation. In addition, a process of drying may be performed after the surface painting layer is formed on the molded plastic substrate. The drying process may include drying the surface painting layer, and when the primer coating layer is formed, the drying may be performed simultaneously under the same condition.

The drying condition may be performed at a temperature of about 80 to 120° C. and, or particularly, of about at 80 to 100° C. The drying time may be for about 0.5 to 2 hours, or particularly for about 0.5 to 1 hour. In particular, according to the drying condition such as a drying temperature, a more luxurious fiber texture may be obtained by forming embossing on the surface as the expansion beads included in the surface painting layer expand. Therefore, the shapes and the sizes of the embossing on the surface may be modified by adjusting a drying condition, and thus, the texture of the surface may be diversely formed.

Accordingly, exemplary painted members with the fiber-textured surface according to the present invention may be prepared in a simplified and more economical manner as the surface painting layer including expansion beads may be formed on the molded plastic substrate using a printing method and the expansion beads included in the surface painting layer may be expanded and exposed on the surface to reveal a fiber texture, which is different from the conventional methods in the related art forming a injected member to form surface embossing or to prepare to have a structure covering the surface of an injected article.

Further according to various exemplary embodiments, the painted member with the fiber-textured surface may be used as interior materials for various structures, and particularly, suitable to be used for vehicle interior materials. In certain exemplary embodiments, automotive pillar trim unit may be prepared with the vehicle interior material of the invention. Accordingly, automotive interior materials formed with the painted member with the fiber-textured surface are provided in the present invention.

### EXAMPLES

Hereinafter, the present invention will be described in detail with reference to examples; however, the present invention is not limited to these examples. The numbers of each component in the following Table 1 is % by weight.

### Example 1

A plastic resin in which no embossing was formed was prepared by injecting a polycarbonate resin in a form of a pillar trim unit shape to apply the product as an interior material of an vehicle pillar trim unit. A primer coating layer having a thickness of about 13 μm was prepared on the surface of the plastic substrate using a paint composition formed with polyolefin and polyacrylic urethane.

On the primer coating layer, the surface was coated using the paint composition prepared as in Table 1, and then a surface painting layer having a thickness of about 24 μm was formed by drying for about 40 minutes at a temperature of about 100° C. The painted member was prepared so that the expansion beads included in the surface painting layer of the painted member have an average particle diameter of about 110 μm after drying. The polyester polyol having a molecular weight of about 8,000 Mw was used for surface coating paint to form the surface painting layer, and polyurethane dispersion having a molecular weight of about 10,000 Mw was used.

As the expansion beads, a polypropylene (PP) materials having a particle diameter size of about 80 to 120 μm was used, and as a curing agent, a mixture of 4,0-diphenylmethane diisocyanate (MDI, TCI), 1,6-hexamethylene diisocyanate (HDI, Acros) and isoporone diisocyanate (IPDI, TCI) was used. As an inorganic filler, a SiO₂—Al₂O₃—CaO-based mineral fiber having an average length of about 7 to 8 μm was used.

In addition, as urethane beads, beads having an average particle diameter of about 100 μm is polymerized using polycaprolactone-diol (PCD) having a molecular weight of about 1200 and 1,6-hexamethylene diisocyanate were used. Bis-(2,2,6,6-tetramethyl-4-piperidinyl) sebacate which is commercially available as Tinuvin 770 was used as a light stabilizer, an urethane-based viscosity agent was used as a viscosity agent, and a siloxane-based matting agent was used as a matting agent.

Ethylene glycol and distilled water were used as solvents in order to form the paint composition for coating the surface painting layer as described above.

### Examples 2 to 5

Examples 2 to 5 were prepared as in Example 1 except that the paint compositions for forming the surface painting layer were as shown in Table 1.

### Example 6

Example 6 was prepared as in Example 1 except that the primer coating layer was not formed and the surface painting layer was directly formed on the plastic substrate. The paint composition for forming the surface painting layer was as shown in Table 1.

### Comparative Example 1

As shown in Table 1, the expansion beads and the inorganic filler were not used, and injection molding was carried out so as to have surface embossing by including additives in the injection molding materials. Separate paint was not used since embossing was formed on the surface of the injection molded product.

### Comparative Examples 2 to 4

Comparative Examples 2 to 4 were prepared as in Example 1 except that the paint compositions for forming the surface painting layer were as shown in Table 1.

TABLE 1

| | Exam- | Exam- | Exam- | Exam- | Exam- | Exam- | Comparative | Comparative | Comparative | Comparative |
|---|---|---|---|---|---|---|---|---|---|---|
| Paint Composition | ple1 | ple 2 | ple 3 | ple 4 | ple 5 | ple 6 | Example 1 | Example 2 | Example 3 | Example 4 |
| PEP | 10 | 10 | 10 | 10 | 10 | 10 | 10 | 10 | 10 | 10 |
| PUD | 20 | 20 | 20 | 20 | 20 | 20 | 20 | 20 | 20 | 20 |
| PCP | 10 | 10 | 10 | 10 | 10 | 10 | 10 | 10 | 10 | 10 |
| Curing Agent | 5 | 5 | 5 | 5 | 5 | 5 | 5 | 5 | 5 | 5 |
| Expansion Bead | 5.0 | 2.0 | 5.0 | 7.0 | 2.0 | 9.0 | — | — | 11.0 | 1.0 |
| Pigment | | | | | | | | | | |
| Inorganic Filler | — | — | 5.0 | 2.0 | 7.0 | — | — | 5.0 | 1.0 | 1.0 |
| Urethane Bead | 1.5 | 1.5 | 1.5 | 1.5 | 1.5 | 1.5 | 1.5 | 1.5 | 1.5 | 1.5 |
| Light Stabilizer | 0.5 | 0.5 | 0.5 | 0.5 | 0.5 | 0.5 | 0.5 | 0.5 | 0.5 | 0.5 |
| Viscosity Agent | 0.5 | 0.5 | 0.5 | 0.5 | 0.5 | 0.5 | 0.5 | 0.5 | 0.5 | 0.5 |
| Matting Agent | 0.5 | 0.5 | 0.5 | 0.5 | 0.5 | 0.5 | 0.5 | 0.5 | 0.5 | 0.5 |
| Ethylene Glycol | 5 | 5 | 5 | 5 | 5 | 5 | 5 | 5 | 5 | 5 |
| Distilled Water | Residual | Residual | Residual | Residual | Residual | Residual | Residual | Residual | Residual | Residual |
| | Quantity | Quantity | Quantity | Quantity | Quantity | Quantity | Quantity | Quantity | Quantity | Quantity |

In Table 1, PEP refers to a polyester polyol, PUD refers to a polyurethane dispersion, and PCP refers to a polycarbonate polyol.

The invention has been described in detail with reference to exemplary embodiments thereof. However, it will be appreciated by those skilled in the art that changes may be made in these exemplary embodiments without departing from the principles and spirit of the invention, the scope of which is defined in the appended claims and their equivalents.

### TEST EXAMPLES

### Test Example

For member specimen each prepared in Examples and Comparative examples, physical properties were measured, compared and evaluated under the same conditions by 12 expert panelists.

In each measured criteria, each panelist performed the evaluation by giving grades from 1 that was the lowest to 10 that was the highest, and for each item, 10 evaluation grades excluding the highest grade and the lowest grade were averaged, and the average values of the listed criteria are shown in Table 2.

TABLE 2

| | Exam- | Exam- | Exam- | Exam- | Exam- | Exam- | Comparative | Comparative | Comparative | Comparative |
|---|---|---|---|---|---|---|---|---|---|---|
| Items | ple 1 | ple 2 | ple 3 | ple 4 | ple 5 | ple 6 | Example 1 | Example 2 | Example 3 | Example 4 |
| Surface Slip Sensitivity | 7 | 7 | 9 | 8 | 8 | 8 | 2 | 7 | 3 | 5 |
| Surface Cushion Sensitivity | 9 | 7 | 9 | 8 | 8 | 9 | 2 | 2 | 9 | 5 |
| Abrasion Resistance | 8 | 8 | 8 | 8 | 8 | 7 | 9 | 3 | 2 | 8 |
| Scratch Resistance | 8 | 8 | 8 | 8 | 8 | 7 | 9 | 3 | 3 | 8 |
| Chemical Resistance | 8 | 8 | 8 | 8 | 8 | 8 | 8 | 5 | 4 | 6 |
| Light Resistance | 8 | 8 | 8 | 8 | 8 | 8 | 8 | 8 | 8 | 8 |
| Thermal Resistance | 8 | 8 | 8 | 8 | 8 | 8 | 8 | 8 | 8 | 8 |
| Moisture Resistance | 8 | 8 | 8 | 8 | 8 | 8 | 8 | 8 | 8 | 8 |

From the test evaluation results, it was demonstrated that, when the expansion beads were used in the amounts as described above, substantial improvements in properties may be obtained in all aspects. In addition, it was verified that the expansion beads may expand when drying the paint thereby providing cushion sensitivity to the coating film, and the inorganic filler may contribute to slip sensitivity of the coating film. Accordingly, when the expansion bead pigments and the inorganic filler are all included in the paint, improved surface slip sensitivity and cushion sensitivity may be achieved.

As described above, according to the present invention, textures having similarity to natural fibers may be obtained when surface slip sensitivity and cushion texture are achieved at the same time. Furthermore, the expansion beads may be properly used for providing the physical properties of the coating film, and in particularly, substantially improved physical properties may be obtained when the inorganic filler is additionally added thereto.

Accordingly, the painted member with the fiber texture according to various exemplary embodiments of the present invention may be used as interior materials or vehicle interior materials for which various plastic interior structures may be used. In particular, the painted member with the fiber texture may be used for interior materials of an automotive pillar trim unit as vehicle interior materials.

What is claimed is:

1. A painted member with a fiber-textured surface comprising:
a molded plastic substrate; and
a surface painting layer that includes expansion beads coated thereon,
wherein the expansion beads included in the surface painting layer are exposed to the surface, and the fiber-textured surface is obtained by the expansion beads.

2. The painted member of claim 1 further comprising:
a primer coating layer disposed between the molded plastic substrate and the surface painting layer including expansion beads coated thereon.

3. The painted member of claim 1, wherein the surface painting layer is formed in a thickness of about 20 to 50 μm.

4. The painted member of claim 1, wherein the surface painting layer further contains an inorganic filler.

5. The painted member of claim 1, wherein the expansion beads included in the surface painting layer have a particle diameter size of about 50 to 500 μm after being dried.

6. The painted member of claim 4, wherein the inorganic filler is a SiO₂—Al₂O₃—CaO-based mineral fiber.

7. The painted member of claim 4, wherein the inorganic filler is a mineral fiber having a length of about 5 to 10 μm.

8. The painted member of claim 1, wherein the surface painting layer further contains one or more selected from the group consisting of: urethane beads, a light stabilizer, a viscosity agent, and a matting agent as additives.

9. The painted member of claim 2, wherein the primer coating layer includes polyolefin, polyacrylic urethane or combinations thereof.

10. The painted member of claim 2, wherein the primer coating layer has a thickness of about 1 to 20 μm.

11. A method for preparing a painted member with a fiber-textured surface, comprising:
preparing a molded plastic substrate;
forming a surface painting layer by coating a paint composition which contains expansion bead on the surface of the molded plastic substrate; and
drying the surface painting layer.

12. The method for preparing a painted member of claim 11, further comprising:
coating a primer coating layer after preparing the molded plastic substrate and before forming the surface painting layer.

13. The method for preparing a painted member of claim 11, wherein the paint composition includes polyester polyol, polyurethane dispersion, polycarbonate polyol or combinations thereof

14. The method for preparing a painted member of claim 11, wherein the paint composition further includes a curing agent.

15. The method for preparing a painted member of claim 11, wherein the expansion beads of the surface painting layer are included in an amount of about 1 to 10% by weight in the paint composition coated to the surface painting layer.

16. The method for preparing the painted member of claim 11, wherein the inorganic filler is further included in an amount of about 1 to 10% by weight in the paint composition coated for forming the surface painting layer.

17. The method for preparing a painted member of claim 11, wherein the drying is performed at a temperature of about 80 to 120° C.

18. The method for preparing a painted member of claim 11, wherein the fiber texture of the surface painting layer is modified by adjusting the size of the expansion bead included in the surface painting layer while adjusting a drying temperature in the drying process.

19. An automotive interior material formed with the painted member with the fiber-textured surface of claim 1.

20. The automotive interior material of claim 19, wherein the interior material is an automotive pillar trim unit.
